(19) United States
(12) Patent Application Publication
(10) Pub. No.: US 2025/0340080 A1
(43) Pub. Date: Nov. 6, 2025

(54) SEMI-FINISHED PRODUCT FOR PRODUCING A PHOTO BOOK, SET FOR PRODUCING A PHOTO BOOK, PHOTO BOOK AND A METHOD FOR PRODUCING A PHOTO BOOK

(71) Applicant: PELEMAN INDUSTRIES NV, Puurs (BE)

(72) Inventors: Guido Frans M. Peleman, Knokke-Heist (BE); Pawan Moradia, Cumming, GA (US)

(73) Assignee: PELEMAN INDUSTRIES NV, Puurs (BE)

(21) Appl. No.: 18/865,948

(22) PCT Filed: Apr. 4, 2023
(86) PCT No.: PCT/IB2023/053413

§ 371 Date: Nov. 14, 2024

(30) Foreign Application Priority Data
May 16, 2022 (BE) 20225367

(51) Int. Cl. B42D 1/08

(52) U.S. Cl. CPC B42D 1/08

(57) ABSTRACT

A semi-finished product for producing a photo book, the semi-finished product includes a film with two sides of which a first side is printable and a number of carriers which are successively applied on a second side of the film. The relative distance between the successive carriers when the carriers extend in the same plane is alternately equal to or less than one millimetre or equal to twice the thickness of a carrier or deviates less than one millimetre therefrom.

### CROSS-REFERENCE TO RELATED APPLICATIONS

The present application is the National Phase entry of International Patent Application No. PCT/IB2023/053413 filed Apr. 4, 2023, which claims priority to Belgium Patent Application No. 2022/5367 filed May 16, 2022, the entire contents of both are hereby incorporated by reference into this application.

### TECHNICAL FIELD

The present disclosure relates to a semi-finished product for producing a photo book, set for producing a photo book, photo book and a method for producing a photo book.

### BACKGROUND

A photo book is understood to mean a book or album in which one or more photographs are shown. Although the present disclosures mostly refers to photographs, the present disclosure is also suitable for images, figures, other kinds of printing and the like.

Traditionally, photo books exist with separate pages that are bound and whereby the photographs continue across different pages.

A disadvantage of said photo books is that there is always a small space between the pages where the photograph is interrupted.

Photo books also exist whereby the pages near the middle are provided with a fold line whereby the printing continues across said fold line. Although the pages of such photo books are relatively flat, the space between the pages continues to exist.

Another disadvantage is that said photo books use paper on which the photographs are printed. Although the photographs do indeed continue over different pages, minor damage to these fold lines occurs because the fibres of the paper are broken at the level of said fold lines. A part of the photographs that continues across said fold lines will thus appear blurred or in any case not look nice and perfect anymore.

The existing methods for producing such photo books are that the machines for producing such photo books are very expensive and can only be used for producing such photo books.

Consequently, the photo books produced with such machines are very expensive.

The purpose of the present disclosure is to provide a solution to the aforementioned and other disadvantages.

### SUMMARY

To this end, the present disclosure relates to a semi-finished product for producing a photo book, whereby the semi-finished product comprises a film with two sides of which a first side is printable and a number of carriers which are successively applied on a second side of the film, whereby the relative distance between the successive carriers when said carriers extend in the same plane is alternately equal to or less than one millimetre or equal to twice the thickness of a carrier or deviates less than one millimetre therefrom.

Note that the relative distance between the carriers is defined here when the carriers extend in the same plane. In practice this means that the film and the carriers are flat on a surface, although the semi-finished product is intended to form a book, whereby the carriers are stacked on top each other.

It is of course also possible to consider this semi-finished product as an end product after printing, without binding it or without providing the semi-finished product with a cover or the like.

An aspect of said semi-finished product is that the film and the carriers can be fed into a plotter in a very simple way, said plotter then being able to print the printable side with photographs.

Thus, no special or expensive machine is required for printing said semi-finished product. Almost every conventional plotter is able to print film of said semi-finished product.

In some embodiments, the thickness of the carriers is between 0.05 and 5 millimetres and in some embodiments the thickness of the carriers is between 0.1 and 2 millimetres.

Said thicknesses allow the semi-finished product to be fed into almost every conventional plotter, whereas said carriers still sufficiently support the film.

Very thin carriers, up to 0.05 millimetres in thickness, are possible when synthetic materials are used such as, for example, polyester, polyvinyl chloride or polystyrene.

In some embodiments, the film is made from polypropylene.

An aspect of using a film made from polypropylene is that this results in a very neat fold line in which no visible fibres are broken or damaged. The parts of the photographs that continue over the fold lines will thus be shown perfectly, unlike when conventional paper were to be used.

In some embodiments, the carriers are made from synthetic material, for example, polypropylene.

An aspect of such synthetic materials is that they do not absorb liquid and thus do not swell up either such that the glued film could warp.

In other possible embodiments, the carriers can also be made from metal, plastic-coated or laminated cardboard or plastic-coated or laminated thick paper.

Untreated wood, cardboard or thick paper are not excluded, but are maybe avoided due to the possible moisture absorption.

Such materials still offer sufficient strength at limited thicknesses to support the film.

In some embodiments, the dimensions of the carriers are identical or almost identical to each other.

This ensures that the carriers can be neatly stacked on top of each other without protruding or indented edges.

In some embodiments, the film and the carriers possess a length and a breadth, whereby the breadth of the film corresponds with the breadth of the carriers.

This ensures that the film is sufficiently supported over its entire breadth, but that at the same time no edges of the carriers protrude outside the breadth of the film. The latter would indeed be aesthetically unacceptable.

In some embodiments, the length of the film corresponds with the sum of the lengths of all carriers increased with the relative distances between the carriers.

This has the aspect that the film is supported maximally by the carriers lengthways as well, and that no edges of carriers protrude outside the contours of the film lengthways either.

In some embodiments, the carriers on the film are applied by gluing.

This ensures a strong, yet quickly applicable connection between carriers and film.

The present disclosure also relates to a set for producing a photo book, said set comprising a cover and the semi-finished product according to the present disclosure.

The cover comprises a binding element and a spine with two endpapers, whereby the spine comprises a base and two upright legs, whereby the binding element is applied in the spine of the cover and whereby the binding element comprises a binding leaf which is applied in the spine of the cover by an adhesive strip, all this such that two edges of the binding leaf extend parallel with the longitudinal direction of the spine, whereby the adhesive strip extends near the middle between said two edges, whereby on the level of said edges on the side of the binding leaf facing away from the spine, a layer of self-adhesive glue is provided, said layer of self-adhesive glue being provided with a protective film.

Such set of cover and semi-finished product allows a professionally looking photo book to be produced in a very simple way and using affordable techniques with photographs that continue across different pages and without visible fold lines.

The present disclosure also relates to a photo book, said photo book being produced with the set according to the present disclosure and also relates to a method for producing a photo book according to the present disclosure, whereby the method comprises the following steps:
providing a semi-finished product according to the present disclosure;
feeding the semi-finished product into a plotter;
printing the printable side of the semi-finished product;
folding the semi-finished product by making alternating mountain-folds and valley-folds such that the carriers come to lie on top of each other;
applying the semi-finished product in a cover.

In some embodiments, applying the semi-finished product in the cover comprises the following steps:
installing the semi-finished product in the spine of the cover;
removing the protective film;
pressing the layer of self-adhesive glue on the semi-finished product.

In some embodiments, pressing the layer of self-adhesive glue on the semi-finished product is realised by closing the cover.

Such method allows a professionally looking photo book to be produced with photographs in a very simple way and using very simple materials that continue across different pages and without visible fold lines.

### BRIEF DESCRIPTION OF THE DRAWINGS

With the intention of better showing the characteristics of the present disclosure, hereinafter, by way of an example without any limiting nature, embodiments are described of a semi-finished product for producing a photo book, a set for producing a photo book, a photo book and a method for producing a photo book according to the present disclosure, with reference to the accompanying drawings, wherein:

FIG. 1 schematically shows a top view of a semi-finished product according to the present disclosure;

FIG. 2 shows a side view of the same semi-finished product as FIG. 1 according to the arrow F2 from FIG. 1;

FIG. 3 shows the semi-finished product in a folded condition;

FIG. 4 shows another embodiment of the folded semi-finished product;

FIG. 5 shows a set according to the present disclosure;

FIG. 6 shows a photo book according to the present disclosure;

FIG. 7 shows the photo book of FIG. 6, but this time opened on a random page;

FIG. 8 shows the photo book of FIG. 6, but this time opened on another random page.

### DETAILED DESCRIPTION

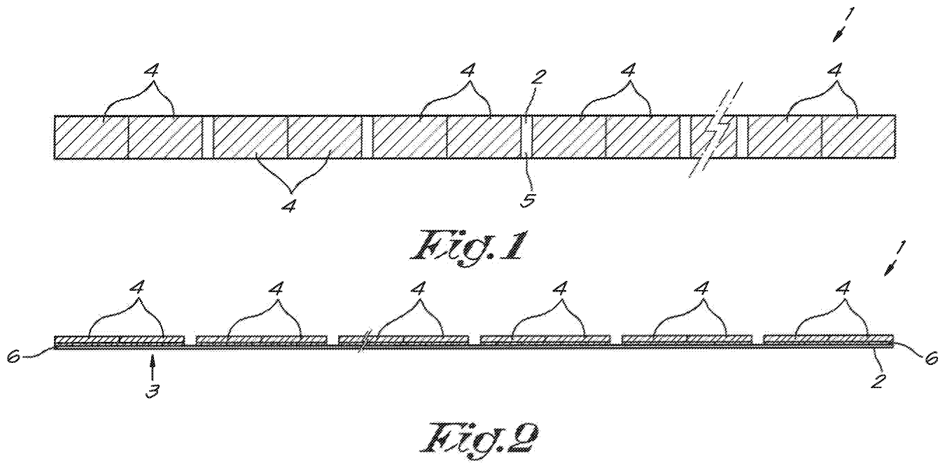

FIG. 1 schematically shows a semi-finished product 1 comprising a film 2 with two sides of which a first side 3 is printable and a number of carriers 4.

Said carriers 4 are successively applied on a second side 5 of the film 2, whereby the relative distance between the successive carriers 4, in this figure, alternately is equal to or less than one millimetre or is equal to twice the thickness of a carrier 4 or deviates less than one millimetre therefrom.

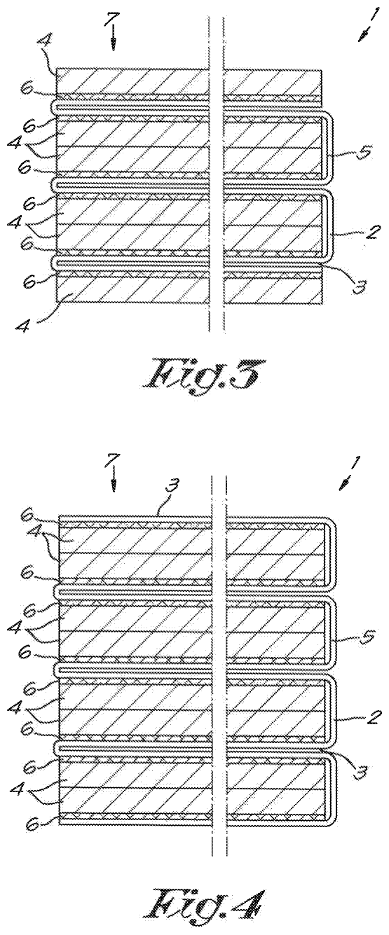

FIG. 2 shows the same semi-finished product 1 as FIG. 1, but in another view. This figure clearly shows that the carriers 4 on the film 2 are attached by a layer of glue 6 which is applied to this end between the film 2 and the carriers 4.

Although the layer of glue 6 in this figure is only applied where the carriers 4 are provided, it is also possible that said layer of glue 6 is continuously applied over the entire second side 5 of the film 2. However, the disadvantage of such embodiment is that in this way the spaces between the carriers 4 are less flexible and that dirt could remain stuck on the layer of glue 6 in said spaces.

The layer of glue 6 can be applied both on the film 2 and on the carriers 4.

Note that the film 2 in FIGS. 1 and 2 is shown flat, whereby the carriers 4 all extend in the same plane.

This example also clearly shows that in this case the breadth of the carriers 4 corresponds with the breadth of the film 2 and that the length of the film 2 corresponds with the sum of the lengths of all carriers 4 increased with the relative distances between the carriers 4.

The thickness of the carriers 4, in this example, amounts to 1.2 millimetres, but it is not excluded that said thickness is between 0.1 and 2 millimetres or even between 0.05 and 5 millimetres.

The film 2 is, in this case but not necessarily, made from polypropylene, whereas the carriers 4 are made from polyester. However, the carriers 4 could also be produced from another synthetic material, metal, plastic-coated or laminated cardboard or plastic-coated or laminated thick paper.

Untreated wood, cardboard or thick paper are not excluded, but may be avoided due to the possible moisture absorption.

It is also possible that the film 2 is produced from a printable synthetic material other than polypropylene, such as for example polyethylene or polyethylene terephthalate.

FIG. 3 shows the same semi-finished product 1 as FIGS. 1 and 2, but this time the film 2 is folded by an alternating mountain-fold and valley-fold such that the carriers 4 come to lie on top of each other to form a stack or bundle 7.

In other words, the fold lines are situated between the carriers 4, this means that the carriers 4 themselves are not folded but that folds are executed between the carriers 4.

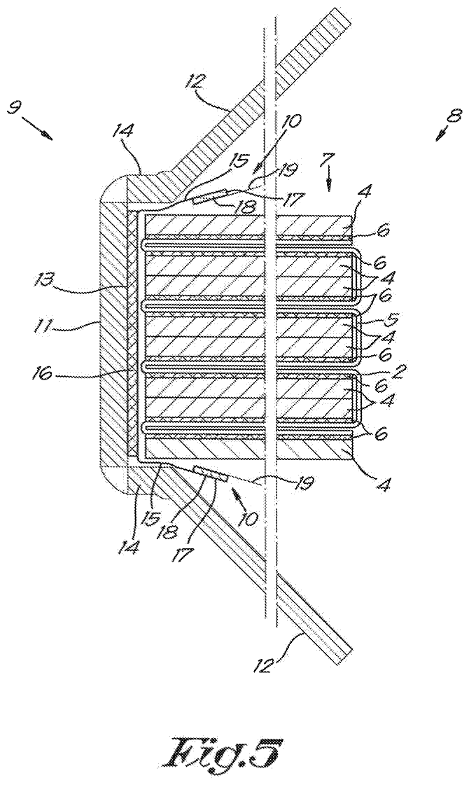

FIG. 4 shows another embodiment whereby the film 2 is also applied over the sides of the carriers 4 located on the upperside and underside of the aforementioned stack or bundle 7.

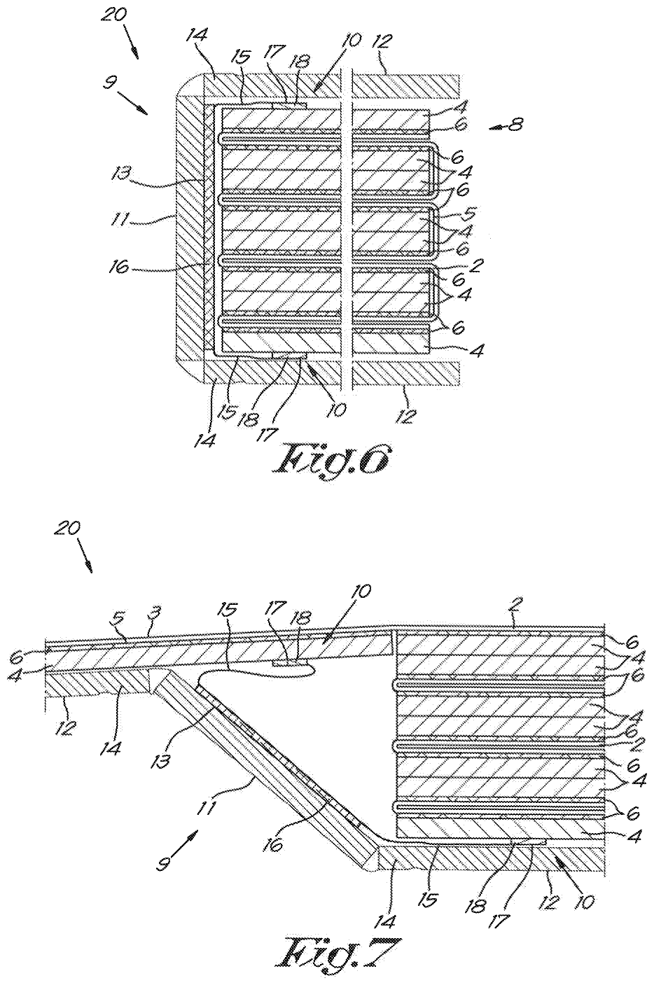

FIG. 5 shows a set 8 consisting of the semi-finished product 1 of FIGS. 1 to 3 and a cover 9.

The cover 9 shown in FIGS. 5 to 8 is only intended by way of an example and the present disclosure is not limited to the use of said type of cover 9. The semi-finished product 1 is indeed applicable in very many different types of cover 9.

The cover 9 comprises a binding element 10 and a spine 11 with two endpapers 12. The spine 11 in turn comprises a base 13 and two upright legs 14, whereby the binding element 10 is applied in the spine 11 of the cover 9.

The binding element 10 comprises a binding leaf 15 which is applied in the spine 11 of the cover 9 by an adhesive strip 16, all this such that two edges 17 of the binding leaf 15 extend in parallel with the longitudinal direction of the spine 11.

The adhesive strip 16 extends near the middle between said two edges 17, whereby on the level of said edges 17 on the side of the binding leaf 15 facing away from the spine 11, a layer of self-adhesive glue 18 is provided, said layer of self-adhesive glue 18 being provided with a protective film 19.

FIG. 6 shows a finished photo book 20, produced with the set 8 of FIG. 3.

Note that the protective films 19 of the binding leaf 15 are removed and that the layer of self-adhesive glue 18 is now applied against the inside of the endpapers 12.

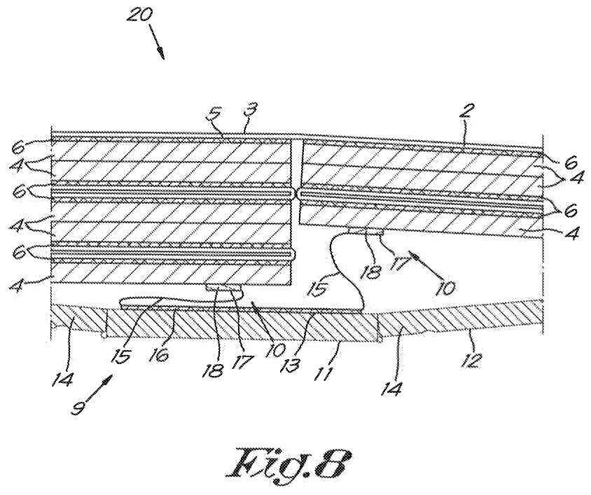

FIG. 7 shows the same photo book 20 as FIG. 6, but this time the photo book 20 is opened on a random page.

Because the carriers 4, which support the opened page, come to lie almost flat, or closely, against each other and because of the structure of the film 2, no visible fold line is present in the middle of the opened page, where the carriers 4 meet each other.

In FIG. 8 the photo book 20 is opened on another random page. It is clearly visible here that the carriers 4 are at no point attached to each other and that they are only connected to the film 2 by the layer of glue 6.

A method for producing such photo book 20 comprises the following steps:
providing a semi-finished product 1 according to the present disclosure, as shown in FIGS. 1 and 2;
feeding the semi-finished product 1 into a plotter;
printing the printable side of the semi-finished product 1;
folding the semi-finished product 1 by making alternating mountain-folds and valley-folds such that the carriers 4 come to lie on top of each other, as shown in FIG. 3 or 4;
applying the semi-finished product 1 in a cover 9, as shown in FIG. 5.

The method for applying the semi-finished product 1 in the cover 9 comprises the following steps in this example:
installing the semi-finished product 1 in the spine 11 of the cover 9;
removing the protective film 19;
pressing the layer of self-adhesive glue 18 on the semi-finished product 1, as shown in FIG. 6.

In this embodiment, the method for pressing the layer of self-adhesive glue 18 on the semi-finished product 1 is realised by closing the cover 9.

It is understood that the cover 9 and the binding element 10 and also the film 2 and the carriers 4 could have any form or dimension without departing from the scope of the present disclosure.

It goes without saying that the adhesive strip 16 between the spine 11 and the binding element 10 and the layer of self-adhesive glue 18 of the aforementioned edges 17 of the binding element 10 can also be executed discretely instead of continuously. For example, dots of glue which are applied at suitable distances from each other and in this way also form a strip or layer.

Similarly, the layer of glue 6 between the film 2 and the carriers 4 can be executed discretely instead of continuously.

It is understood that said layer of glue 6 can also be applied over the entire second side 5 of the film 2 and not only where the carriers 4 are provided.

As already mentioned, the cover 9 can be executed in many different ways. The semi-finished product 1 is applicable in many different types of cover 9.

The semi-finished product can also be used as an end product, without binding in a cover 9.

If relevant, the semi-finished product can also be applied in an adapted box or the like.

The present disclosure is by not limited to the embodiment described as an example and shown in the figures, but a semi-finished product for producing a photo book, a set for producing a photo book, a photo book and a method for producing a photo book according to the present disclosure can also be realised in all kinds of forms and dimensions without departing from the scope of the present disclosure.

1. A semi-finished product for producing a photo book, the semi-finished product comprises:
a film with two sides of which a first side is printable; and
a number of carriers which are successively applied on a second side of the film,
wherein a relative distance between the successive carriers when the carriers extend in a same plane is alternately equal to or less than one millimetre or equal to twice a thickness of a carrier or deviates less than one millimetre therefrom.

2. The semi-finished product according to claim 1, wherein the thickness of the carriers is between 0.05 and 5 millimetres.

3. The semi-finished product according to claim 1, wherein the film is produced from polypropylene.

4. The semi-finished product according to claim 1, wherein the carrier is produced from cardboard, thick paper, wood, metal, or synthetic material.

5. The semi-finished product according to claim 1, wherein dimensions of the carriers are substantially identical.

6. The semi-finished product according to claim 1, wherein the film and the carriers possess a length and a breadth, wherein the breadth of the film corresponds with the breadth of the carriers.

7. The semi-finished product according to claim 1, wherein the film and the carriers possess a length and a breadth, wherein the length of the film corresponds with a sum of the lengths of all of the carriers increased with the relative distances between the carriers.

8. The semi-finished product according to claim 1, wherein the carriers on the film are applied by a layer of glue under the carriers.

9. A set for producing a photo book, the set comprises a cover and the semi-finished product according to claim 1.

10. The set according to claim 9, wherein the cover includes a binding element and a spine with two endpapers,
wherein the spine includes a base and two upright legs,
wherein the binding element is applied in the spine of the cover and wherein the binding element a binding leaf which is applied in the spine of the cover by an adhesive strip, such that two edges of the binding leaf extend parallel with a longitudinal direction of the spine,
wherein the adhesive strip extends near a middle between the two edges, wherein on a level of the two edges on a side of the binding leaf facing away from the spine a layer of self-adhesive glue is provided, the layer of self-adhesive glue being provided with a protective film.

11. A photo book, the photo book is produced with the set according to claim 9.

12. A method for producing the photo book according to claim 11, the method below comprises the following steps:
providing the semi-finished product;
feeding the semi-finished product into a plotter;
printing the printable side of the semi-finished product;
folding the semi-finished product by making alternating mountain-folds and valley-folds such that the carriers come to lie on top of each other; and
applying the semi-finished product in a cover.

13. The method according to claim 12, wherein applying the semi-finished product in the cover comprises the following steps:
installing the semi-finished product in the spine of the cover;
removing a protective film from a layer of self-adhesive;
pressing the layer of self-adhesive glue on the semi-finished product.

14. The method according to claim 13, wherein pressing the layer of self-adhesive glue on the semi-finished product is realised by closing the cover.

15. The semi-finished product according to claim 1, wherein the thickness of the carriers is between 0.1 and 2 millimetres.
